(19) United States
(12) Patent Application Publication
(10) Pub. No.: US 2018/0099479 A1
(43) Pub. Date: Apr. 12, 2018

(54) THERMOPLASTIC CARBON FIBER LAMINATE WITH A RANDOMLY ORIENTED FIBER REINFORCED CORE LAYER

(71) Applicant: Dell Products L.P., Round Rock, TX (US)

(72) Inventors: Nicholas D. Abbatiello, Round Rock, TX (US); David Wheeler Williams, Salado, TX (US)

(21) Appl. No.: 15/289,004

(22) Filed: Oct. 7, 2016

(51) Int. Cl. B32B 5/26; B32B 5/02; B32B 5/12; G06F 1/18; G06F 1/16

(52) U.S. Cl. CPC B32B 5/26; B32B 5/022; B32B 5/024; B32B 5/12; G06F 1/181; G06F 1/1633; B32B 2262/106; B32B 2250/20; B32B 2260/023; B32B 2260/046; B32B 2307/546; B32B 2307/72; B32B 2457/00; B32B 2250/03

(57) ABSTRACT

A thermoplastic carbon fiber laminate with a randomly oriented fiber reinforced core layer provides a low cost, low weight, and high stiffness material for mechanical panels used in portable information handling systems.

### BACKGROUND

### Field of the Disclosure

This disclosure relates generally to information handling systems and, more particularly, to a thermoplastic carbon fiber laminate with a randomly oriented fiber reinforced core layer for information handling systems.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Advancements in packaging design have reduced both the weight and thickness of information handling systems. In particular, components included in portable information handling systems, such as laptops, notebooks, and tablet form factors, are the object of efforts to reduce weight and thickness, without compromising structural strength.

As overall weight of portable information handling systems decreases, the weight contribution of mechanical components has come under increased scrutiny by product designers. Although reducing the thickness of a mechanical component will reduce weight, an undesirable reduction in structural rigidity may also occur with thinner mechanical components.

In particular, when the mechanical component comprises a carbon fiber laminate with multiple layers, different technologies are available to reduce weight, but may not meet design criteria for cost and structural rigidity (stiffness).

### SUMMARY

In one aspect, a disclosed carbon fiber composite material may include a first outer layer further comprising a first thermoplastic matrix reinforced with first directional carbon fiber. The carbon fiber composite material may further include a core layer bonded to the first outer layer, the core layer further comprising a second thermoplastic matrix reinforced with non-woven carbon fiber. The carbon fiber composite material may also include a second outer layer bonded to the core layer, the second outer layer further comprising a third thermoplastic matrix reinforced with second directional carbon fiber.

In any of the disclosed embodiments of the carbon fiber composite material, the first directional carbon fiber and the second directional carbon fiber may consist of a continuous carbon fiber weave.

In any of the disclosed embodiments of the carbon fiber composite material, the first directional carbon fiber and the second directional carbon layer may consist of continuous unidirectional carbon fiber.

In any of the disclosed embodiments of the carbon fiber composite material, the non-woven carbon fiber comprises discrete carbon fiber with random orientation.

In any of the disclosed embodiments of the carbon fiber composite material, the non-woven carbon fiber comprises recycled carbon fiber.

In any of the disclosed embodiments of the carbon fiber composite material, the first thermoplastic matrix, the second thermoplastic matrix, and the third thermoplastic matrix consist of the same material.

In any of the disclosed embodiments of the carbon fiber composite material, the first thermoplastic matrix, the second thermoplastic matrix, and the third thermoplastic matrix comprise the same material.

In any of the disclosed embodiments of the carbon fiber composite material, the first thermoplastic matrix is thermally bonded to the second thermoplastic matrix, and the third thermoplastic matrix is thermally bonded to the second thermoplastic matrix.

Other disclosed aspects include a mechanical panel for use in portable information handling systems including the carbon fiber composite material, and an information handling system including the carbon fiber composite material.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 is a block diagram of selected elements of an embodiment of a thermoplastic carbon fiber laminate with a randomly oriented fiber reinforced core layer; and

FIG. 3 is flowchart depicting selected elements of an embodiment of a method for manufacturing a thermoplastic carbon fiber laminate with a randomly oriented fiber reinforced core layer part for use in an information handling system.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

As noted previously, current information handling systems may demand ever thinner and lighter products, without sacrificing strength and stability. In particular, weight reduction in portable information handling systems may be attained by optimizing the materials used to construct display panel covers, palm rest covers, and rear panel doors, among other mechanical panels and components. However, in addition to weight, new materials for such mechanical components are subject to cost and stiffness criteria as well. As will be described in further detail, the inventors of the present disclosure have developed a thermoplastic carbon fiber laminate with a randomly oriented fiber reinforced core layer for use in portable information handling systems. The disclosed thermoplastic carbon fiber laminate with a randomly oriented fiber reinforced core layer is a low density material to enable thin and lightweight components, such as panels, while meeting expectations for low cost and high stiffness as well.

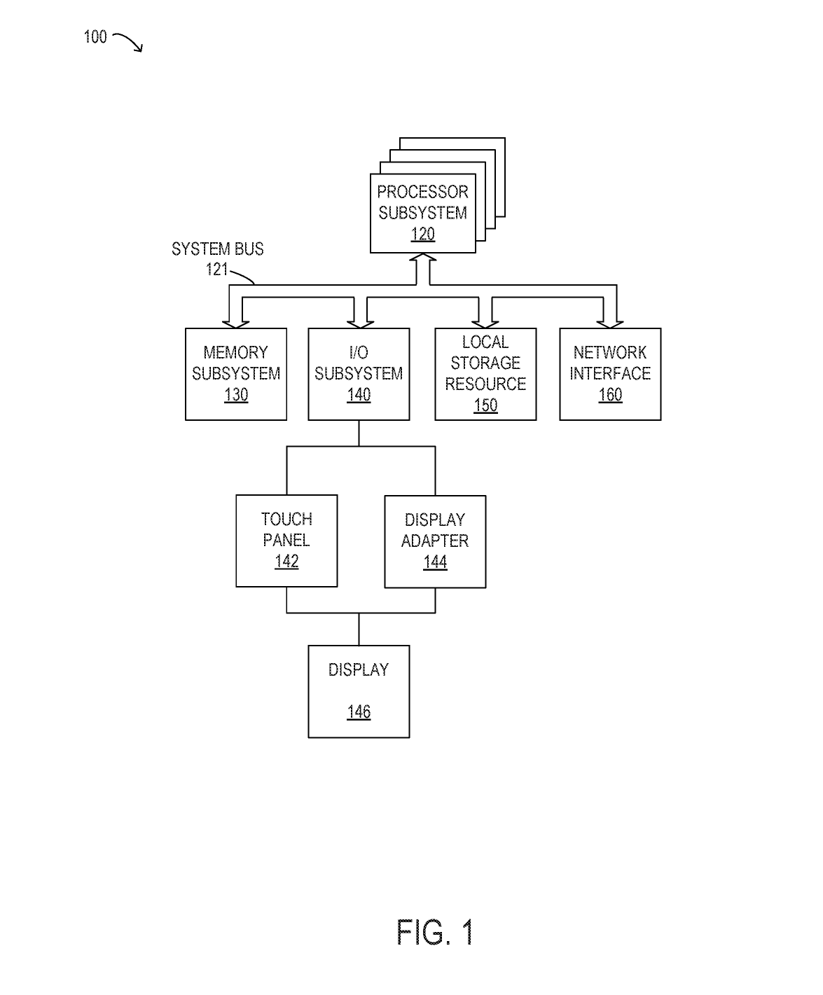

Particular embodiments are best understood by reference to FIGS. 1, 2, and 3 wherein like numbers are used to indicate like and corresponding parts.

Turning now to the drawings, FIG. 1 illustrates a block diagram depicting selected elements of an embodiment of information handling system 100. As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and execute program instructions or process data. In some embodiments, processor subsystem 120 may interpret and execute program instructions or process data stored locally (e.g., in memory subsystem 130 or another component of physical hardware 102). In the same or alternative embodiments, processor subsystem 120 may interpret and execute program instructions or process data stored remotely (e.g., in network storage resource 170).

Also in FIG. 1, memory subsystem 130 may comprise a system, device, or apparatus operable to retain and retrieve program instructions and data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and a suitable selection or array of volatile or non-volatile memory that retains data after power to its associated information handling system, such as system 100, is powered down. Local storage resource 150 may comprise computer-readable media (e.g., hard disk drive, floppy disk drive, CD-ROM, or other type of rotating storage media, flash memory, EEPROM, or another type of solid state storage media) and may be generally operable to store instructions and/or data. In information handling system 100, I/O subsystem 140 may comprise a system, device, or apparatus generally operable to receive and transmit data. I/O subsystem 140 may represent, for example, a variety of communication interfaces, graphics interfaces, video interfaces, user input interfaces, or peripheral interfaces. As shown, I/O subsystem 140 may comprise touch panel 142 and display adapter 144. Touch panel 142 may include circuitry for enabling touch functionality in conjunction with display 146 that is driven by display adapter 144.

When information handling system 100 is portable information handling system, at least certain mechanical components, such as display cover panels, or other external panels, may be constructed using a thermoplastic carbon fiber laminate with a randomly oriented fiber reinforced core layer, as described in further detail herein.

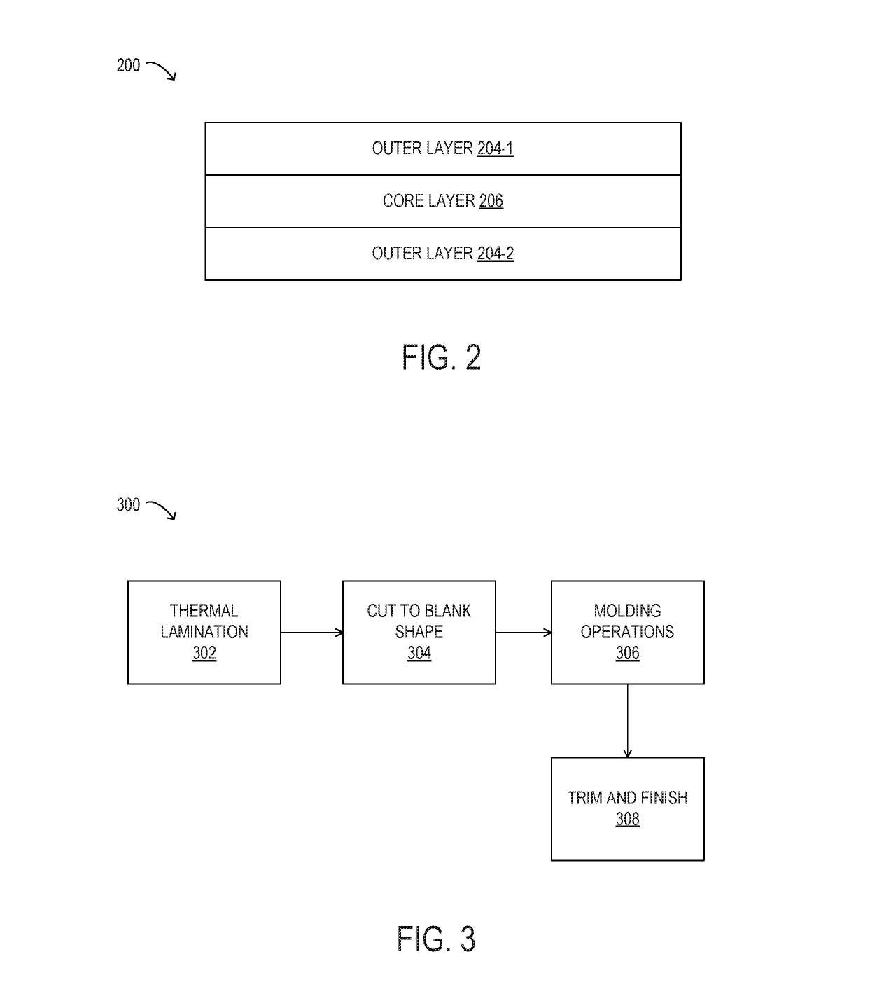

Turning now to FIG. 2, selected elements of an embodiment of thermoplastic carbon fiber laminate with a randomly oriented fiber reinforced core layer are illustrated. As shown, the thermoplastic carbon fiber laminate is also referred to as a non-woven thermoplastic carbon fiber laminate 200 comprising three layers: outer layers 204-1 and 204-2, as well as core layer 206. FIG. 2 is not drawn to scale but is a schematic illustration showing an exemplary three layer construction. It is noted that in some embodiments, fewer or more layers may be included in a non-woven thermoplastic carbon fiber laminate.

As noted above, in a typical construction of thermoplastic laminates used for information handling systems, a low weight and, thus, a low material density are desirable. It is often the choice of the core layer that is used to reduce overall density, such as by using a resin core or a honeycomb core. However, it has been observed that, even when very stiff fibers are used to reinforce the outer layers, such as carbon fiber weave, core layers constructed of resin or honeycomb often result in reduced overall flexural stiffness, which is undesirable. Furthermore, the use of a so-called “directional carbon fiber”, which refers to carbon fiber in the form of a weave or a unidirectional carbon fiber layer, may add cost to the overall laminate, which is also undesirable.

As shown in FIG. 2, non-woven thermoplastic carbon fiber laminate 200 includes core layer 206 comprised of non-woven carbon fiber reinforced thermoplastic material. As used herein, “non-woven carbon fiber” refers to randomly oriented discrete carbon fibers. In core layer 206, non-woven carbon fiber having fiber lengths of greater than about 1 inch may be used in one embodiment as fiber reinforcement having isotropic stiffening properties. In various embodiment the size or length of the carbon fibers may vary, such as between 0.1 inch and 2 inches in length, from about 0.5 inches to 1.5 inches in length, or greater than about 0.5 inches in length. The non-woven carbon fiber used may be virgin (new) or recycled carbon fiber material. As a result of the random, anisotropic orientation of the carbon fibers, non-woven thermoplastic carbon fiber laminate 200 achieves a very high stiffness at a relatively low cost, which is desirable for construction of mechanical components for portable information handling systems.

As shown in FIG. 2, outer layers 204-1 and 204-2 may be comprised of a directional carbon fiber reinforced thermoplastic material. As noted, directional carbon fiber is a weave or a unidirectional (parallel) fiber layer. The orientation of the directional carbon fiber may be different or the same between outer layers 204-1 and 204-2. It is further noted that the overall thickness of non-woven thermoplastic carbon fiber laminate 200 may be less than 2 mm thick, less than 1.6 mm thick, or less than 1.4 mm thick, in various embodiments. In particular, core layer 206 may be less than 1.4 mm thick, or about 1.0 mm thick in different embodiments. For example, when an overall size of a panel created using non-woven thermoplastic carbon fiber laminate 200 is 335 mm×230 mm, corresponding to about a 14″ display screen cover, a load of 100N applied at the center of the panel may result in a deflection of less than about 3.6 mm when the overall thickness of non-woven thermoplastic carbon fiber laminate 200 is 1.4 mm, with core layer 206 being 1.0 mm thick. Thus, even when outer layers 204-1 and 204-2 contain relatively expensive directional carbon fiber, because core layer 206 may comprise a substantial portion of the overall volume of non-woven thermoplastic carbon fiber laminate 200, the cost reduction or cost savings from the use of non-woven carbon fiber in core layer 206 may result in a meaningful impact on overall cost. For example, in comparison to using glass fiber reinforcement in core layer 206, the use of non-woven carbon fiber may result in an overall weight reduction greater than 20% while achieving a cost savings of about 30%, while still achieving comparable stiffness.

In given embodiments, outer layers 204-1, 204-2 and core layer 206 may be formed using thermoplastic matrix compositions comprising polycarbonate or polysulfonate. In various embodiments, the same thermoplastic matrix may be used in outer layer 204-1, 204-2, and core layer 206. In some embodiments, different thermoplastic matrix compositions may be used in one or more individual layers of non-woven thermoplastic carbon fiber laminate 200. It is noted that the layers in non-woven thermoplastic carbon fiber laminate 200 may be thermally bonded together without the use of an adhesive or bonding agent, by raising the temperature until the thermoplastic matrix in each layer softens or melts, and then pressing the layers together such that the thermoplastic matrix forms a continuous or pseudo-continuous phase in the overall laminate, which is desirable for optimal strength and stiffness.

Referring now to FIG. 3, a block diagram of selected elements of an embodiment of process 300 for manufacturing parts using a thermoplastic carbon fiber laminate with a randomly oriented fiber reinforced core layer for use in a portable information handling system (such as information handling system 100) is depicted in flowchart form. It is noted that certain operations described in process 300 may be optional or may be rearranged in different embodiments.

In process 300, at step 302 thermal lamination may be performed on the layers used to manufacture a particular part. For example, in step 302, outer layers 204-1, 204-2 and core layer 206 may be thermally bonded together. Step 302 may be performed using a rolling mill to manufacture a roll of thermoplastic carbon fiber laminate with a randomly oriented fiber reinforced core layer from individual rolls of the constituent materials, as described above with respect to FIG. 2. Step 302 may be performed using individual discrete sheets to manufacture a sheet of non-woven thermoplastic carbon fiber laminate. The thermal lamination in step 302 may apply suitable temperatures and pressures, according to the particular material compositions used, such as for the thermoplastic matrix used in each individual layer. Then, at step 304, a blank may be cut to shape from the thermally laminated material generated in step 302. The blank may be stamped or machined to shape, depending on the intricacy or specific features on a particular part being manufactured by process 300. Next, at steps 306 and 308, the blank manufactured in step 304 may be subject to molding operations and trim and finish, respectively. It is noted that the exact process steps included in steps 306 and 308 may vary depending on the type of mold operation used. In a first example, in step 306, a first thermoforming molding operation may be performed to initially shape the blank. In the first example, after trimming in step 306, a second insert molding operation may be performed to add a secondary polymer layer to the blank. The secondary polymer layer may include an aesthetic or design element, such as for an external surface of the final part that is exposed to human handling by end users. Then in the second example, at step 308, the final surface treatment of the finished part may be performs, such as painting or application of surface films. In a second example, in step 306, a hybrid molding operation may be performed in which the blank is shaped using thermoforming molding, and then the secondary polymer layer is injection molded into the same mold. In the second example, in step 308, the hybrid molded part may be trimmed and surface finished, as described in the first example. In a third example, in steps 306 and 308, hybrid molding may be performed to create the final part, including the application of any surface finishing within the mold.

As disclosed herein, a thermoplastic carbon fiber laminate with a randomly oriented fiber reinforced core layer provides a low cost, low weight, and high stiffness material for mechanical panels used in portable information handling systems.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A carbon fiber composite material, comprising:
a first outer layer further comprising a first thermoplastic matrix reinforced with first directional carbon fiber;
a core layer bonded to the first outer layer, the core layer further comprising a second thermoplastic matrix reinforced with non-woven carbon fiber; and
a second outer layer bonded to the core layer, the second outer layer further comprising a third thermoplastic matrix reinforced with second directional carbon fiber,
wherein at least one of the first thermoplastic matrix, the second thermoplastic matrix, and the third thermoplastic matrix comprises polysulfonate.

2. The carbon fiber composite material of claim 1, wherein the first directional carbon fiber and the second directional carbon fiber consist of a continuous carbon fiber weave.

3. The carbon fiber composite material of claim 1, wherein the first directional carbon fiber and the second directional carbon fiber consist of continuous unidirectional carbon fiber.

4. The carbon fiber composite material of claim 1, wherein the non-woven carbon fiber comprises discrete carbon fiber with random orientation.

5. The carbon fiber composite material of claim 1, wherein the non-woven carbon fiber comprises recycled carbon fiber.

6. The carbon fiber composite material of claim 1, wherein the first thermoplastic matrix, the second thermoplastic matrix, and the third thermoplastic matrix consist of the same material.

7. The carbon fiber composite material of claim 1, wherein the first thermoplastic matrix, the second thermoplastic matrix, and the third thermoplastic matrix comprise the same material.

8. The carbon fiber composite material of claim 1, wherein the first thermoplastic matrix is thermally bonded to the second thermoplastic matrix, and the third thermoplastic matrix is thermally bonded to the second thermoplastic matrix.

9. A mechanical panel for use in portable information handling systems, the mechanical panel comprising:
a first outer layer further comprising a first thermoplastic matrix reinforced with a first directional carbon fiber layer;
a core layer bonded to the first outer layer, the core layer further comprising a second thermoplastic matrix reinforced with a non-woven carbon fiber layer; and
a second outer layer bonded to the core layer, the second outer layer further comprising a third thermoplastic matrix reinforced with a second directional carbon fiber layer,
wherein at least one of the first thermoplastic matrix, the second thermoplastic matrix, and the third thermoplastic matrix comprises polysulfonate.

10. The mechanical panel of claim 9, wherein the first directional carbon fiber layer and the second directional carbon fiber layer consist of a continuous carbon fiber weave.

11. The mechanical panel of claim 9, wherein the first directional carbon fiber layer and the second directional carbon fiber layer consist of continuous unidirectional carbon fiber.

12. The mechanical panel of claim 9, wherein the non-woven carbon fiber layer comprises discrete carbon fiber with random orientation.

13. The mechanical panel of claim 9, wherein the non-woven carbon fiber layer comprises recycled carbon fiber.

14. The mechanical panel of claim 9, wherein the first thermoplastic matrix, the second thermoplastic matrix, and the third thermoplastic matrix consist of the same material.

15. The mechanical panel of claim 9, wherein the first thermoplastic matrix, the second thermoplastic matrix, and the third thermoplastic matrix comprise the same material.

16. The mechanical panel of claim 9, wherein the first thermoplastic matrix is thermally bonded to the second thermoplastic matrix, and the third thermoplastic matrix is thermally bonded to the second thermoplastic matrix.
